(19) United States
(12) Patent Application Publication
(10) Pub. No.: US 2025/0018885 A1
(43) Pub. Date: Jan. 16, 2025

(54) WIRE HARNESS

(71) Applicant: Proterial, Ltd., Tokyo (JP)

(72) Inventors: Hirotaka ESHIMA, Tokyo (JP); Yoshikazu HAYAKAWA, Tokyo (JP); Takahiro FUTATSUMORI, Tokyo (JP)

(21) Appl. No.: 18/767,016

(22) Filed: Jul. 9, 2024

(30) Foreign Application Priority Data
Jul. 11, 2023 (JP) 2023-113584

(51) Int. Cl. B60R 16/02; H01B 7/00; H02G 3/04

(52) U.S. Cl. CPC B60R 16/0215; H01B 7/0045; H02G 3/0481

(57) ABSTRACT

A wiring harness includes a first cable and a second cable, a one-side connector arranged on one end of the first cable, and a cover member covering at least a portion of each of the first and second cables together with a portion of the one-side connector.

### CROSS-REFERENCE TO RELATED APPLICATIONS

The present patent application claims the priority of Japanese patent application No. 2023-113584 filed on Jul. 11, 2023, and the entire contents thereof are hereby incorporated by reference.

### TECHNICAL FIELD

This invention relates to a wire harness.

### BACKGROUND OF THE INVENTION

Conventionally, a wiring harness having multiple connectors and cables is used, for example, to electrically connect multiple connection objects in a vehicle. The wiring harness described in Patent Document 1 is equipped with a first wire group, one end of which is connected to a first connector and an other end to a second connector, and a second wire group, one end of which is connected to a first connector and an other end is connected to a third connector, while diverging from the first wire group at the position of the second connector or an object to be attached to the second connector. In the portion between the second and third connectors, an exterior material such as corrugated tube or adhesive tape wound spirally is provided to cover the second wire group.

### CITATION LIST

### Patent Literature 1

Japanese Patent No. 6761398

### SUMMARY OF THE INVENTION

When a wiring harness configured as described above is, for example, placed between the body-side and the wheel-side in a vehicle, it is prone to chipping caused by stones and other objects bounced up by the tires. In the one described in Patent Document 1, the second wire group is protected by an exterior material. However, when a corrugated tube is used as the exterior material, if the position of the corrugated tube in the longitudinal direction of the second wire group is not fixed, there is a risk that the area prone to chipping cannot be properly protected. In addition, when adhesive tape is used as an exterior material, more work is required to wind the adhesive tape in a spiral shape, and there is a risk of peeling due to a decrease in adhesiveness over time.

Therefore, the object of the present invention is to provide a wiring harness capable of suppressing damage caused by chipping and the like.

For the purpose of solving the above problem, the present invention provides a wiring harness comprising a first cable and a second cable; a one-side connector arranged at one end of the first cable, and a cover member that covers at least a portion of the second cable together with a part of the one-side connector.

### Effects of the Invention

According to the wire harnesses of the present invention, it is possible to suppress damage due to chipping and the like.

### BRIEF DESCRIPTION OF DRAWINGS

FIG. 1 is a schematic diagram showing a configuration example of a vehicle equipped with a wiring harness according to an embodiment of the present invention.

FIG. 2A is an enlarged partial view of FIG. 1.

FIG. 2B is an explanatory diagram showing the cover member in FIG. 2A in two dotted lines virtually and the interior of the cover member in solid lines.

FIG. 3 is a configuration diagram of the wiring harness.

FIG. 4A is a cross-sectional view taken along the line A-A of FIG. 3.

FIG. 4B is a cross-sectional view taken along the line B-B of FIG. 3.

FIG. 4C is a cross-sectional view taken along the line C-C of FIG. 3.

FIG. 5 is a perspective view showing the cover member alone.

FIG. 6 is an explanatory diagram illustrating the first connector and its surrounding wiring configuration.

FIG. 7 is a perspective view showing a variation of the cover member.

FIG. 8 is a diagram showing a variation of the wiring structure for trunk and branch cables.

### DETAILED DESCRIPTION OF THE INVENTION

### Embodiment

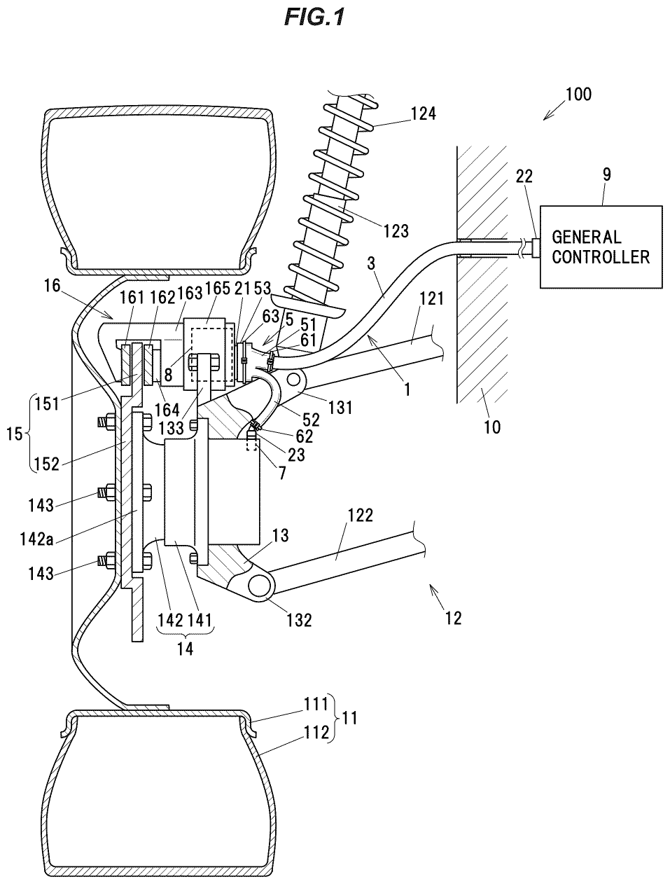

FIG. 1 is a schematic diagram showing a configuration example of a vehicle 100 equipped with a wiring harness 1 according to an embodiment of the present invention. In the vehicle 100, a vehicle wheel 11 having a wheel 111 and a tire 112 is supported against a vehicle body 10 by a suspension system 12. The suspension system 12 comprises an upper arm 121, a lower arm 122, a damper 123, and a suspension spring 124. The upper arm 121 and the lower arm 122 are connected respectively at one end to a knuckle 13 and at an other end to the vehicle body 10.

The knuckle 13 has a first connecting section 131 to which the upper arm 121 and the damper 123 are connected, a second connecting section 132 to which the lower arm 122 is connected, and a mounting section 133 to which an electric brake unit 16 is attached. Also, an outer wheel 141 of a hub unit 14, which rotatably supports the vehicle wheel 11, is fixed to the knuckle 13.

The hub unit 14 has the outer wheel 141 and a hub wheel 142 that is rotatably supported with respect to the outer wheel 141. A plurality of rolling elements that are not shown in the drawing, are arranged between the inner surface of the outer wheel 141 and the outer surface of the hub wheel 142, being held by a retainer. The hub wheel 142 has a wheel mounting flange 142a, to which the wheel 111 is attached together with a brake rotor 15 by a plurality of hub bolts 143. The brake rotor 15 integrally has a friction portion 151 that frictionally slides with brake pads 161, 162 of the electric brake unit 16 and a fixing portion 152 that is fixed to the wheel mounting flange 142a of the hub wheel 142.

A wheel speed sensor 7 is mounted on the outer wheel 141 of the hub unit 14. The wheel speed sensor 7 detects the rotation speed of the hub wheel 142 relative to the outer wheel 141 as the rotation speed of the vehicle wheel 11. Specifically, it detects changes in the magnetic field of a magnetic encoder attached to the hub wheel 142 using a magnetic field detection element such as a Hall IC and outputs a pulse signal with a pulse interval corresponding to the rotation speed of the hub wheel 142 relative to the outer wheel 141 as a detection signal.

The electric brake unit 16 has an outer brake pad 161 and an inner brake pad 162, a caliper 163 with the outer brake pad 161 attached, a piston 164 with the inner brake pad 162 attached, and a caliper bracket 165 fixed to the mounting section 133 of the knuckle 13. The caliper 163 is supported by the caliper bracket 165 and can move parallel to the axis of rotation of the vehicle wheel 11.

The vehicle 100 has a brake controller 8 that controls the electric brake unit 16 and a general controller 9 that controls the vehicle 100 comprehensively. The brake controller 8 and the wheel speed sensor 7 are located on the wheel side and move vertically with the vehicle wheels 11 relative to the vehicle body 10 as the suspension springs 124 extend and retract. The general controller 9 is located on the body side of the vehicle. The brake controller 8 is an aspect of “wheel-side control device” of the present invention, and the general controller 9 is an aspect of “vehicle body-side control device” of the present invention.

The wiring harness 1 connects the brake controller 8, the wheel speed sensor 7, and the general controller 9. Next, the configuration of the wiring harness 1 will be explained in detail.

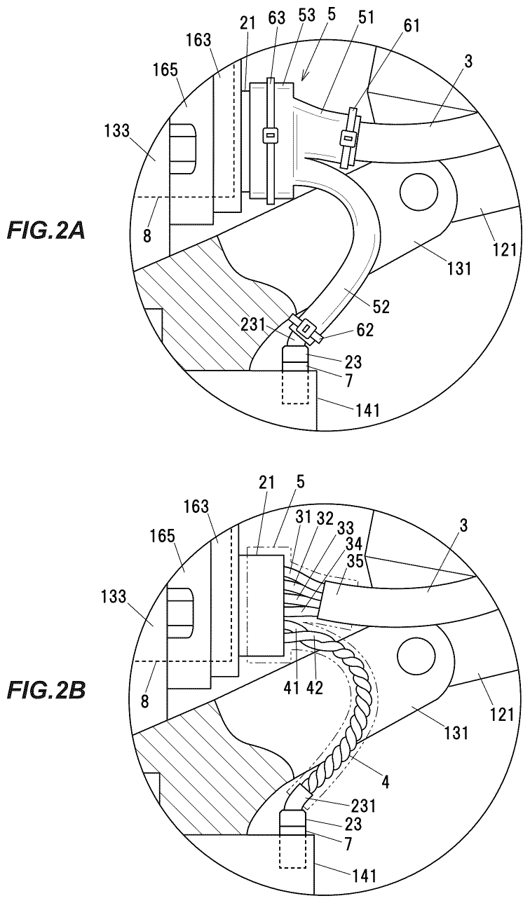

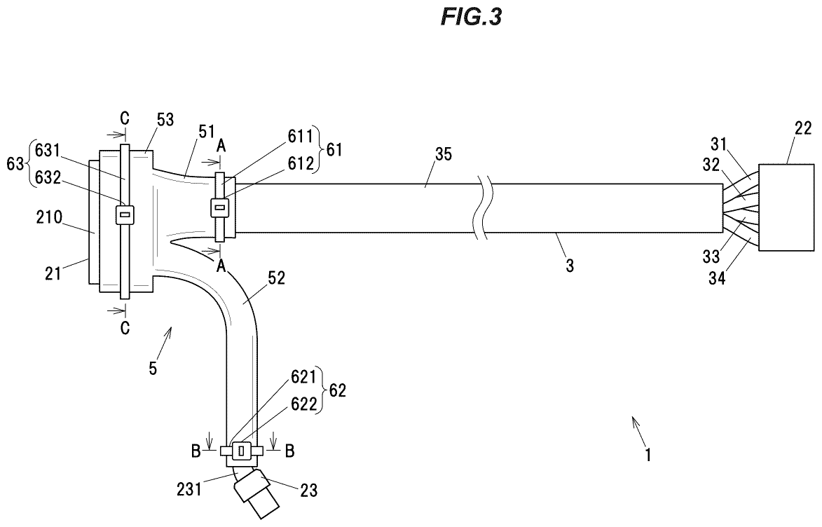

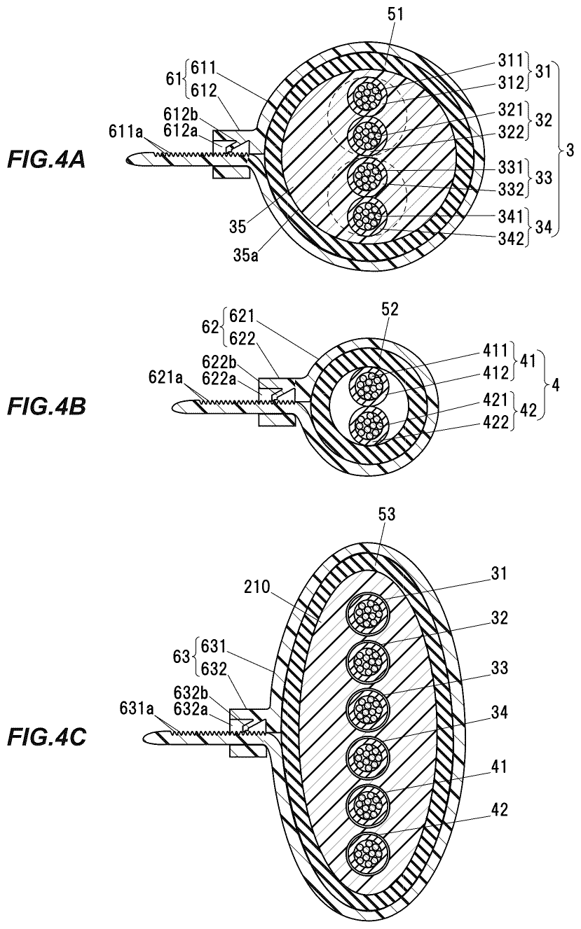

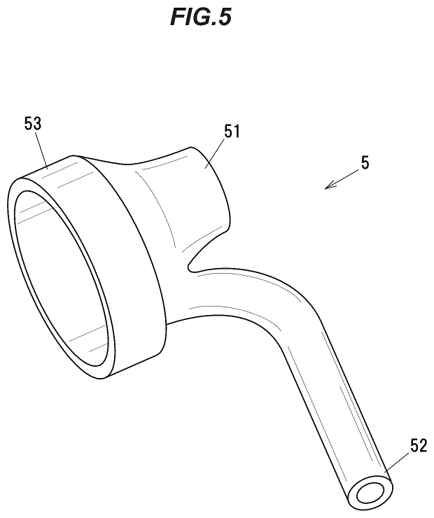

FIG. 2A is an enlarged partial view of FIG. 1. FIG. 2B is an explanatory diagram of FIG. 2A showing the cover member 5 of the wiring harness 1 as two dotted lines virtually and the interior of the cover member 5 as solid lines. FIG. 3 is a configuration diagram of the wiring harness 1. FIG. 4A is a cross-sectional view taken along the line A-A in FIG. 3. FIG. 4B is a cross-sectional view taken along the line B-B in FIG. 3. FIG. 4C is a cross-sectional view taken along the line C-C in FIG. 3. FIG. 5 is a perspective view of the cover member 5 alone.

The wiring harness 1 consists of a first connector 21 that is detachably attached to the brake controller 8, a second connector 22 that is detachably attached to the general controller 9, a trunk cable 3 between the first connector 21 and the second connector 22, a branch cable 4 that extends from the first connector 21 side in a direction different from the trunk cable 3, the third connector 23 attached to the end of the branch cable 4 and detachably attached to the wheel speed sensor 7, the rubber cover member 5, and the first to third clamping members 61 to 63.

The first connector 21 is an aspect of the “one-side connector” of the present invention, and the second connector 22 is an aspect of the “other-side connector” of the present invention. The trunk cable 3 is an aspect of the “first cable” of the present invention, and the branch cable 4 is an aspect of the “second cable” of the present invention. The trunk cable 3 is longer than the branch cable 4, has more wires than the branch cable 4, and has a larger outer diameter than the branch cable 4.

The trunk cable 3 has first through fourth signal lines 31 to 34 and a sheath 35 covering the first through fourth signal lines 31 to 34. The first and second signal lines 31, 32, and the third and fourth signal lines 33, 34 are respectively twisted together to form twisted pair wires. The first through fourth signal lines 31 to 34 are insulated wires consisting of center conductors 311, 321, 331, 341 respectively covered by insulators 312, 322, 332, 342. The center conductors 311, 321, 331, 341 are stranded wires consisting of a plurality of wires made of copper or copper alloys twisted together. The insulators 312, 322, 332, 342 are made of an insulating resin such as polyethylene or fluororesin. The sheath 35 is made of a resin such as urethane, for example. In the present embodiment, the sheath 35 is formed by enhanced extrusion, and an outer surface 35a of the sheath 35 is circular. In the present embodiment, the trunk cable 3 comprises the first through fourth signal lines 31 to 34 (signal lines only), but it may comprise a combination of multiple power lines (for supplying power to the electric brake unit 16) and multiple signal lines.

The branch cable 4 has fifth and sixth signal lines 41, 42. The fifth and sixth signal lines 41, 42 are insulated wires consisting of center conductors 411, 421 covered with insulators 412, 422, which are twisted together to form twisted pair wires. The center conductors 411, 421 are twisted wires consisting of a plurality of wires made of copper or copper alloy. The insulators 412, 422 are made of an insulating resin such as polyethylene or fluororesin. Additionally, the fifth and sixth signal lines 41, 42 may not be twisted together. The fifth and sixth signal lines 41, 42 transmit the detection signals of the wheel speed sensor 7.

The cover member 5 has a first cylindrical portion 51 that covers a portion of the trunk cable 3 (sheath 35, and the first through fourth signal lines 31 to 34 exposed from the sheath 35), a second cylindrical portion 52 that covers at least a portion of the branch cable 4, and a connector cover portion 53 that covers a portion of the first connector 21 in one piece. In the present embodiment, the cover member 5 is made of EPDM (ethylene propylene rubber). However, the material of the cover member 5 is not limited to EPDM, and any suitable material (butyl rubber, silicone rubber, fluoro rubber, etc.) can be used as long as it has elasticity, water resistance, and necessary weather resistance and durability. The cover member 5 is formed, for example, by pouring molten rubber material into a mold and allowing it to solidify. The first cylindrical portion 51, the second cylindrical portion 52, and the connector cover portion 53 are made of the same rubber material.

The length of the second cylindrical portion 52 from the connector cover portion 53 is longer than the length of the first cylindrical portion 51 from the connector cover portion 53. This is because the length between the first connector 21 and the third connector 23 of the branch cable 4 is longer than the length of the exposed portions of the first through fourth signal lines 31 to 34 from the sheath 35. This makes it possible to protect the first through fourth signal lines 31 to 34 and the branch cable 4 that are exposed from the sheath 35 from chipping and the like. At the same time, it makes it possible to suppress unnecessary lengthening of the first cylindrical portion 51, and thus, for example, the weight of the cover member 5 can be reduced. Also, the second cylindrical portion 52 has smaller inner and outer diameters than the first cylindrical portion 51. As shown in FIG. 5, the cover member 5 has the second cylindrical portion 52 curved so that the tip of the second cylindrical portion 52 faces the wheel speed sensor 7 in a natural state where no external force is applied. The curvature of the second cylindrical portion 52 prevents a part of the second cylindrical portion 52 from being bent and compressing the fifth and sixth signal lines 41, 42 when the wiring harness 1 is assembled to the vehicle 100, or prevents the second cylindrical portion 52 from being torn by wear and tear.
third connector 23 has a cylindrical protruding portion 231, and the second cylindrical portion 52 (a part of the third connector 23) is secured to the protruding portion 231. The third connector 23 has a part including the tip of the protruding portion 231, housed inside the second cylindrical portion 52. The stiffness of the material of the protruding portion 231 is higher than the stiffness of the material of the second cylindrical portion 52. In the present embodiment, the second cylindrical portion 52 covers the entirety of the fifth and sixth signal lines 41, 42 between the first connector 21 and the third connector 23. However, if the second cylindrical portion 52 covers at least a portion of the fifth and sixth signal lines 41, 42 between the first connector 21 and the third connector 23, the second cylindrical portion 52 can protect the fifth and sixth signal lines 41, 42 and prevent the branch cable 4 from being damaged by chipping or other causes.

The tip of the first cylindrical portion 51 is tightened by a first clamping member 61. The first clamping member 61 tightens the tip of the first cylindrical portion 51 toward the sheath 35. The tip of the second cylindrical portion 52 is tightened by a second clamping member 62. The second clamping member 62 is disposed around the outer periphery of the protruding portion 231 of the third connector 23 and tightens the tip of the second cylindrical portion 52 toward the protruding portion 231 of the third connector 23. The connector cover portion 53 is tightened by the third clamping member 63 toward a connector housing 210 of the first connector 21. The first through third clamping members 61 to 63 inhibit foreign matter, such as moisture, from entering inside the cover member 5 and also inhibit misalignment of the first cylindrical portion 51, the second cylindrical portion 52, and the connector cover portion 53.

The first through third clamping members 61 to 63 have band-shaped portions 611, 621, and 631 on which a plurality of mastoids (locking protrusions) 611a, 621a, and 631a are formed along the longitudinal direction, and heads 612, 622, and 632 disposed at one end of the band-shaped portions 611, 621, and 631. The heads 612, 622, and 632 have insertion holes 612a, 622a, and 632a into which band-shaped portions 611, 621, and 631 are respectively inserted, and stoppers 612b, 622b, and 632b that stop any of the plurality of mastoids 611a, 621a, and 631a inside the insertion holes 612a, 622a, and 632a. The first through third clamping members 61 to 63 are made of nylon resin, for example, but may be made of metal such as stainless steel. As a means for fastening the cover member 5 to the trunk cable 3, the first connector 21, and the third connector 23, an adhesive tape may be arranged so that an adhesive layer contacts the cover member 5, the trunk cable 3, the first connector 21, and the third connector 23.

When assembling the wiring harness 1, insert the tips of the band-shaped portions 611, 621, 631 of the first through third clamping members 61 to 63, into the insertion holes 612a, 622a, 632a, and pull the band-shaped portions 611, 621, 631 out of the insertion holes 612a, 622a, 632a until an appropriate tightening force is generated. Each of the stoppers 612b, 622b, 632b engages one of the mastoids 611a, 621a, 631a, which is located within the insertion holes 612a, 622a, 632a respectively, when each of the band-shaped portions 611, 621, 631 is drawn out the longest. The excess length of the band-shaped portions 611, 621, 631 drawn out of the insertion holes 612a, 622a, 632a may be cut using nippers or the like.

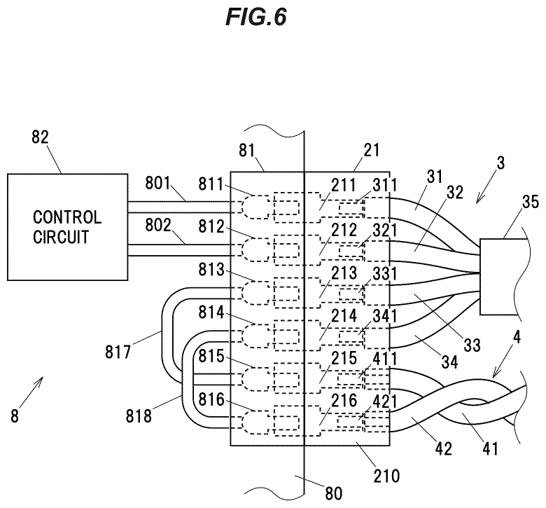

FIG. 6 is an explanatory diagram illustrating the first connector and its surrounding wiring configuration. The first connector 21 has the connector housing 210 made of resin and first through sixth terminals 211-216 held in the connector housing 210. The respective center conductors 311, 321, 331, 341, 411, 421 of the first through sixth signal lines 31 to 34, 41, 42 are crimped to the first through sixth terminals 211-216. The connector housing 210 is made of a material that is more rigid than the material of the cover member 5. The connector housing 210 houses a portion of each of the first through sixth signal lines 31 to 34, 41, 42 and a portion of each of the first through sixth terminals 211-216.

The first connector 21 is mated to a connection connector 81 mounted on a substrate 80 of the brake controller 8. The connection connector 81 has first to sixth connection terminals 811 to 816 to which first to sixth terminals 211 to 216 of the first connector 21 are connected respectively. Of these, the first and second connection terminals 811, 812 are connected to a control circuit 82 of the brake controller 8 by wiring patterns 801, 802 formed on the substrate 80. The control circuit 82 controls the electric motor that is the driving source of the electric brake unit 16, based on the control signals sent from the general controller 9. The caliper 163 and piston 164 of the electric brake unit 16 are operated by the driving force of the electric motor.

The brake controller 8 and the general controller 9 communicate via the first and second signal lines 31, 32 of the trunk cable 3. The first and second signal lines 31, 32 transmit control signals between the brake controller 8 and the general controller 9. The control signals sent from the general controller 9 to the brake controller 8 include information on the braking force of the vehicle wheel 11 to be generated by the electric brake unit 16. The control signals sent from the brake controller 8 to the general controller 9 include information indicating the operating state of the electric brake unit 16, such as the rotation speed of the electric motor and the current supplied to the electric motor.

A third connection terminal 813 and a fifth connection terminal 815, and a fourth connection terminal 814 and a sixth connection terminal 816 of the connection connector 81 are electrically shorted, respectively. As a result, the center conductor 411 of the fifth signal line 41 of the branch cable 4 is electrically connected to the center conductor 331 of the third signal line 33 of the trunk cable 3, and the center conductor 421 of the sixth signal line 42 of the branch cable 4 is electrically connected to the center conductor 341 of the fourth signal line 34 of the trunk cable 3.

In the example shown in FIG. 6, a shorting member 817 electrically connects the third connecting terminal 813 to the fifth connecting terminal 815, and a shorting member 818 electrically connects the fourth connecting terminal 814 to the sixth connecting terminal 816. The shorting members 817 and 818 are metal fittings made of conductive metal. In addition, the third connecting terminal 813 and the fifth connecting terminal 815, and the fourth connecting terminal 814 and the sixth connecting terminal 816 may be electrically short-circuited by a wiring pattern formed on the substrate 80, for example.

The detection signals of the wheel speed sensor 7 transmitted by the fifth and sixth signal lines 41, 42 propagate to the third and fourth signal lines 33, 34 of the trunk cable 3 via the shorting members 817, 818 and are sent to the general controller 9 by the third and fourth signal lines 33, 34 of the trunk cable 3. The general controller 9 sends control signals to the brake controller 8 based on the rotation speed of the vehicle wheel 11 obtained by the detection signal of the wheel speed sensor 7. The control of the braking force by the general controller 9 includes antilock control to suppress the locking of the vehicle wheels 11. Alternatively, a part of the function of controlling the braking force may be provided to the brake controller 8. In this case, the detection signal of the wheel speed sensor 7 is also input to the control circuit 82 of the brake controller 8.

### Advantageous Effect of the Embodiment

According to the embodiment described above, since the cover member 5 covers the branch cable 4 together with a part of the first connector 21, misalignment of the cover member 5 can be deterred and the branch cable 4 can be properly protected. This makes it possible to suppress damage due to chipping and the like of the branch cable 4. Since the cover member 5 also covers a part of the trunk cable 3, it can more reliably deter misalignment of the cover member 5 and also inhibit foreign matter from entering inside the cover member 5. It is also possible to suppress damage due to chipping and the like of the trunk cable 3 (in particular, the first through fourth signal lines 31 to 34 exposed from the sheath 35). Furthermore, in the present embodiment, the first and third clamping members 61 to 63 tighten the tips of the first cylindrical portions 51 and the second cylindrical portions 52 of the cover member 5 and the connector cover portion 53, so that misalignment can be suppressed and foreign matter can be prevented from entering more securely.

### Variation of Cover Member

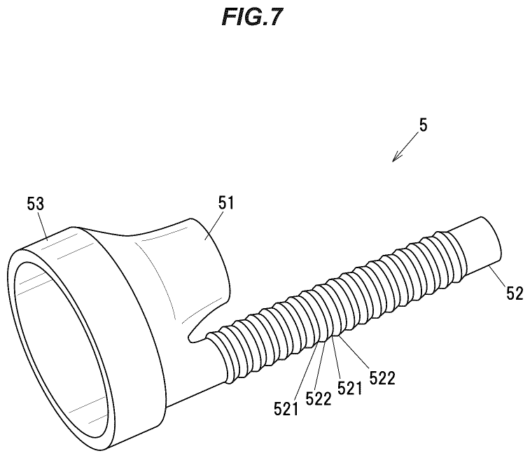

FIG. 7 is a perspective view showing a variation of the cover member 5. As the above embodiment, this cover member 5 has the first cylindrical portion 51, the second cylindrical portion 52, and the connector cover portion 53 in one piece, but the second cylindrical portion 52 has a bellows structure in which a plurality of concave portions 521 and convex portions 522 that are different in outer diameter, are formed alternately. The bellows structure of the second cylindrical portion 52 makes the second cylindrical portion 52 bend easily and prevents the fifth and sixth signal lines 41, 42 from being compressed or the like, by a part of the second cylindrical portion 52 being bent when the wiring harness 1 is assembled to the vehicle 100. On the other hand, the first cylindrical portion 51, which is shorter in length than the second cylindrical portion 52, does not have a bellows structure. This makes it possible to simplify the mold for forming the cover member 5.

In the example shown in FIG. 7, a bellows structure is formed on the second cylindrical portion 52, except its tip portion to which the second clamping member 62 is attached. However, the entire second cylindrical portion 52 may have a bellows structure. In other words, at least a portion of the second cylindrical portion 52 should have a bellows structure.

### Variations of Trunk and Branch Cables

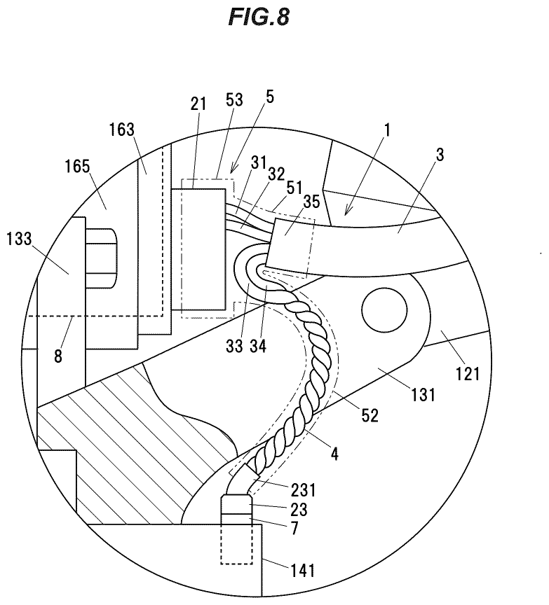

FIG. 8 is a diagram showing a variation of the wiring structure for the trunk cable 3 and the branch cable 4. In FIG. 8, as in FIG. 2, the cover member 5 is shown virtually as two dotted lines, and the interior of the cover member 5 is shown as solid lines. In the above embodiment, the case in which the fifth and sixth signal lines 41, 42 of the branch cable 4 are electrically connected to the third and fourth signal lines 33, 34 of the trunk cable 3 is described, but in the variation shown in FIG. 8, the third and fourth signal lines 33, 34 of the trunk cable 3 derived from the sheath 35 inside the cover member 5 are introduced (with being bent between the end of the sheath 35 and the first connector 21) into the second cylindrical portion 52 without passing through the first connector 21 and the brake controller 8 to form the branch cable 4. In other words, in the above embodiment, the branch cable 4 is separate from the trunk cable 3, but in the present variation, the branch cable 4 is a part of the trunk cable 3. This configuration has the same effect as the above embodiment.

### Summary of the Embodiment

Next, technical ideas understood from the above embodiment and variation, are described with reference to the reference numerals and the like used in the embodiment and variation. However, each reference numeral in the following description does not limit the constituent elements in the scope of claims to the members and the like specifically shown in the embodiment and variation.

According to the first feature, a wiring harness 1 comprising:
a first cable and a second cable (a trunk cable 3 and a branch cable 4),
a one-side connector (a first connector 21) arranged at one end of the first cable 3, and
a cover member 5 covering at least a portion of each of the first and second cables 3, 4 together with a portion of the one-side connector (the first connector 21).

According to the second feature, in the wiring harness 1 as described by the first feature, the cover member 5 integrally comprises a first cylindrical portion 51 covering a portion of the first cable 3, a second cylindrical portion 52 covering at least a portion of the second cable 4, and a connector cover portion 53 covering a portion of the one-side connector 21, and the length of the second cylindrical portion 52 from the connector cover portion 53 is longer than the length of the first cylindrical portion 51 from the connector cover portion 53.

According to the third feature, in the wiring harness 1 as described by the second feature, the tip of the first cylindrical portion 51 is tightened by a first clamping member 61 and the tip of the cylindrical portion 52 is tightened by a second clamping member 62.

According to the fourth feature, in the wiring harness 1 as described by the third feature, the connector cover portion 53 is tightened by a third clamping member 63 toward a connector housing 210 of the one-side connector 21.

According to the fifth feature, in the wiring harness 1 as described by any one of the first to fourth features, the other-side connector a second connector 22 is arranged at the other end of the first cable 3, the object to be attached to the one-side connector 21 is a wheel-side control device (a brake controller 8) located on the wheel side of the vehicle 100, the object to be attached to the other-side connector 22 is a vehicle body-side control device (a general controller 9) located on the body side of the vehicle 100, and the second cable 4 is connected to a wheel speed sensor 7 that detects the rotation speed of the vehicle wheel 11.

According to the sixth feature, in the wiring harness 1 as described by the fifth feature, in the natural state of the cover member 5, the second cylindrical portion 52 is curved in such a manner that the tip of the second cylindrical portion 52 faces the wheel speed sensor 7.

According to the seventh feature, in the wiring harness 1 as described by the fifth feature, at least a portion of the second cylindrical portion 52 has a bellows structure.

That is all for the description of the embodiments and variations of the present invention, but the above embodiments and variations do not limit the invention according to the scope of claims. It should also be noted that not all of the combinations of features described in the embodiments are essential to the means for solving problems of the invention.

The present invention can be implemented with appropriate modifications to the extent that it does not depart from the intent of the invention. For example, the above embodiment describes a case in which the branch cable 4 is connected to the wheel speed sensor 7 via the third connector 23. However, not limited to this, the branch cable 4 may be directly connected to the wheel speed sensor 7 without going through the third connector 23. In this case, the center conductors 411, 421 of the fifth and sixth signal lines 41, 42 are electrically connected to the terminals of the detection element within the case of the wheel speed sensor 7. Also, without installing the third connector 23, a resin molding body (molded resin molding body) may be arranged at the end of the branch cable 4 that collectively covers the magnetic detection element for the wheel speed sensor 7 and the end of the branch cable 4.

The applications of the wiring harness 1 are not limited to those described in the above embodiments, for example, the wiring harness of the present invention can be used to connect other devices, sensors, and the like in a vehicle. In addition, the wiring harnesses of the present invention may be used not only for vehicles, but also for industrial machinery and robots, for example.

1. A wiring harness, comprising:
a first cable and a second cable;
a one-side connector arranged on one end of the first cable; and
a cover member covering at least a portion of each of the first and second cables together with a portion of the one-side connector.

2. The wiring harness, according to claim 1, wherein the cover member has a first cylindrical portion covering a portion of the first cable, a second cylindrical portion covering at least a portion of the second cable, and a connector cover portion covering a portion of the one-side connector, and wherein a length of the second cylindrical portion from the connector cover portion is longer than a length of the first cylindrical portion from the connector cover portion.

3. The wiring harness, according to claim 2, wherein a tip of the first cylindrical portion is tightened by a first clamping member and a tip of the second cylindrical portion is tightened by a second clamping member.

4. The wiring harness, according to claim 3, wherein the connector cover portion is tightened by a third clamping member toward a connector housing of the one-side connector.

5. The wiring harness, according to any one of claims 2, further comprising:
an other-side connector arranged at an other end of the first cable,
wherein an object to be attached to the one-side connector is a wheel-side control device located on a wheel side of a vehicle, wherein an object to be attached to the other-side connector is a vehicle body-side control device located on a body side of the vehicle, and
wherein the second cable is connected to a wheel speed sensor that detects a rotation speed of a vehicle wheel.

6. The wiring harness, according to claim 5, wherein the second cylindrical portion is curved in such a manner that a tip of the second cylindrical portion faces the wheel speed sensor in a natural state of the cover member.

7. The wiring harness, according to claim 5, wherein at least a portion of the second cylindrical portion has a bellows structure.
